(19) United States
(12) Patent Application Publication
(10) Pub. No.: US 2023/0106204 A1
(43) Pub. Date: Apr. 6, 2023

(54) BIODEGRADABLE DISPLAY PROTECTOR

(71) Applicant: David Lee, Calgary (CA)

(72) Inventor: David Lee, Calgary (CA)

(21) Appl. No.: 17/959,349

(22) Filed: Oct. 4, 2022

Related U.S. Application Data
(60) Provisional application No. 63/251,948, filed on Oct. 4, 2021.

(51) Int. Cl. C09J 7/29; C09J 7/20; C09J 7/40; B32B 7/12; B32B 15/09; B32B 15/20; B32B 27/36; B32B 17/06; B32B 27/40

(52) U.S. Cl. CPC C09J 7/29; C09J 7/201; C09J 7/401; C09J 7/405; B32B 7/12; B32B 15/09; B32B 15/20; B32B 27/36; B32B 17/06; B32B 27/40; C09J 2203/326; C09J 2301/41; C09J 2467/005; C09J 2467/006; C09J 2475/006; B32B 2307/536; B32B 2307/748; B32B 2307/7163; B32B 2307/732; B32B 2307/584; B32B 2307/42; B32B 2272/00; B32B 2255/26; B32B 2255/10; B32B 2307/406; B32B 2307/408

(57) ABSTRACT

A biodegradable display protector comprises a top layer; an antimicrobial (AF) layer beneath the top layer; a core layer formed of biodegradable material beneath the AF layer; an adhesive layer beneath the core layer; and a bottom release layer beneath the adhesive layer. The bottom release layer may be peeled off to allow the screen protector to be adhered to a display screen. In the embodiments, biodegradable polyethylene terephthalate (PET) or biodegradable polylactic acid (PLA) may be used for an inflexible protector whereas biodegradable thermoplastic urethane (TPU) may be used for a flexible protector. A thickness of the screen protector may be between about 0.08 mm to about 0.23 mm.

### PRIORITY

This application claims priority to U.S. Prov. Application No. 63/251,948 filed on Oct. 4, 2021, the contents of which are explicitly incorporated by reference in its entirety.

### FIELD

This invention is in the field of display protectors, and more specifically to touch screen protectors and even more particularly to recyclable and/or biodegradable touch screen protectors.

### BACKGROUND

U.S. Pat. No. 9,471,163 B2 discloses a shield that is attachable to a touch sensitive screen.

The shield is attached to the touch sensitive screen only at its outer peripheral portion. An air gap is enclosed between the shield and the touch sensitive screen to form a planar air bearing. The shield does not touch the active area of the touch sensitive screen when the user is not touching the shield but only viewing the touch sensitive screen through the shield. This mitigates unwanted optical artifacts such as trapped air bubbles, Newton rings and chromatic interference while maintaining the sensitivity of the touch sensitive screen.

U.S. Pat. No. 8,044,942 B1 discloses a touch screen protector for a hand held electronic device having a front face that includes a touch screen portion and an outer perimeter. The touch screen protector comprises a plastic film having front and back sides, an outer perimeter that corresponds to that of the device, and a transparent window; and a spacer provided along the outer perimeter of the plastic film surrounding the transparent window, having a thickness sufficient to space the plastic film near but not in contact with the touch screen portion, and an exposed adhesive for removably mounting the protector upon the outer perimeter of the front face to form an enclosed air space between the transparent window of the plastic film, the spacer and the touch screen portion of the device.

U.S. Pat. No. 8,642,173 B2 discloses a multi-layer screen protector for digital display screens, such as LCD's, cell phones, tablets, laptops, and pad computer devices, that may be readily applied without the need for special tools and in dusty environments. The screen protector being designed and die-cut to match the shape of the digital display screen, including cut-outs for cameras, microphones and device buttons, where the top surface is a layer of polycaprolactone aliphatic urethane that is connected to a bottom layer made from plastic such as polystyrene, acrylic and/or polyethylene terephthalate, and a self-wetting adhesive layer provided on the bottom surface of the bottom polystyrene, acrylic and/or polyethylene terephthalate layer. The screen protector provides an optically clear view of the device and is constructed with the abrasion resistant layer being provided and supported on a plastic layer and may be removed and reinstalled.

Canadian Pat. No. 2,815,974 C discloses a touch screen protector for a hand held electronic device having a front face that includes a touch screen portion and a non-functional band. The touch screen protector of the invention comprises a film having front and back sides, an outer perimeter that corresponds to that of the device, and a transparent window; an exposed adhesive or adhesive/spacer provided along the outer perimeter of the film surrounding the transparent window, and multiple dots arranged in a prescribed pitch and present on the back side of the film at a density which is sufficiently high to reduce interference patterns when the transparent window of the protector is pressed against the touch screen portion for operation of the electronic device.

Korean Pat. No. 102200037 B1 discloses a touch screen for a hand-held wireless communication device with a touch-sensitive user interface and a phone operating mode in which a swipe-sensitive user-controlled area of the user interface is activated together with a call information display while a call is coming in. The touch screen cover includes a protective panel that overlays most of the touch-sensitive user interface of the handheld wireless communication device in a shielding structure. The protective panel has a touch communication unit that overlays at least a portion of the swipe detection user control area of the user interface of the handheld wireless communication device in the shielded structure, and the touch communication unit initiates a swiping touch engagement on its exposed outer surface. And in response thereto to impart a sweeping capacitance-induced user actuation to the swipe-sensing user controlled area.

Selke et al., Environ. Sci. Technol. 2015, 49, 6, 3769-3777 discloses biodegradation-promoting additives for polymers are increasingly being used around the world with the claim that they effectively render commercial polymers biodegradable. However, there is a lot of uncertainty about their effectiveness in degrading polymers in different environments. The effect of biodegradation-promoting additives on the biodegradation of polyethylene (PE) and polyethylene terephthalate (PET) is studied. Biodegradation was evaluated in compost, anaerobic digestion, and soil burial environments. None of the five different additives tested significantly increased biodegradation in any of these environments. Thus, no evidence was found that these additives promote and/or enhance biodegradation of PE or PET polymers. So, anaerobic and aerobic biodegradation are not recommended as feasible disposal routes for nonbiodegradable plastics containing any of the five tested biodegradation-promoting additives.

Chinese Pat. No. 102206406 B discloses a method for preparing a transparent heat-resistance polylactic acid modification material, in which three methods for improving the heat resistance of polylactic acid, namely a method for changing a polylactic acid crystal state by using a nucleating agent, a method for changing a polylactic acid molecular structure by the crosslinking of a chain extender and a method for mixing the polylactic acid and high glass transition temperature (Tg) polymer materials, are adopted. The method comprises the following steps of: drying all raw material mixed complexes at 80 DEG C for 5 hours; and granulating or directly processing to form a transparent heat-resistance polylactic acid product. The polylactic acid modification material comprises the following raw materials in parts by weight: 100 parts of polylactic acid, 5-10 parts of chitin whisker polymethyl methacrylate coating, 0.5-2.0 parts of chain extender, 3-5 parts of oligomer polylactic acid, and 0.1-0.5 part of 3-(nonyl-phenyl) phosphite ester. By using the method, the thermal deformation temperature of the polylactic acid composite material is over 100 DEG C, and the biodegradability and the high transparency of the composite material are effectively maintained.

### SUMMARY

The invention may be any and/or all aspects described herein in any and/or all combinations.

According to one aspect, a biodegradable touch screen protector may comprise a top layer; an antimicrobial (AF) layer beneath the top layer; a core layer formed of biodegradable material beneath the AF layer; an adhesive layer beneath the core layer; and a bottom release layer beneath the adhesive layer. The bottom release layer is releasably adhered to the core layer.

According to another aspect, the top layer may be a protective film having a hardness between HD to 9 H hardness. In another aspect, the top layer may be a release film formed of biodegradable polyethylene terephthalate (PET).

According to another aspect, the AF layer may be formed from anyone of octadecyl dimethyl (3-trimethoxysilylpropyl) ammonium chloride, silver and copper antimicrobial film. The bottom release layer may also be formed of biodegradable PET film.

According to a further aspect, the biodegradable material of the core layer may be any one of biodegradable polylactic acid (PLA) resin material, recycled PET and recycled glass. Alternatively, the biodegradable material of the core layer may be a combination of biodegradable thermoplastic urethane (TPU) and PLA material.

According to one aspect, the biodegradable material of the core layer is formed by involving a creation of a chitin nanocrystal formation. The chitin nanocrystal formation may involve mixing distilled water with sodium lauryl sulfonate and methyl methacrylate in a ratio of approximately 100:1:20 to form chitin nanocrystal polymethylmethacrylate. The chitin nanocrystal polymethylmethacrylate may be further mixed with polylactic acid, homopolymerization tetracarboxylic acid dianhydride, oligopolymer polylactic acid, and three-nonylphenol phosphorous acid ester.

According to another aspect, the touch screen protector may further include a layer of polyurethane coating between the core layer and the adhesive layer.

According to another aspect, the touch screen protector may further include a blue light filter layer applied to the core layer to filter out a wavelength of approximately 400-nm to approximately 530-nm.

According to another aspect, the touch screen protector may have a total thickness between about 0.08 mm to about 0.23 mm. For an inflexible touch screen protector, a thickness may be between about 0.1 mm to about 0.23 mm. For a flexible touch screen protector, the thickness may be between about 0.08 mm to about 0.18 mm.

According to one aspect, the PET release film for the top layer and the bottom release layer may have a thickness of 0.05 mm. The AF coating may have a thickness of 0.03 mm. The core layer may have a thickness of 0.04 mm. The polyurethane coating may have a thickness of 0.045 mm. The adhesive layer may have a thickness of 0.025 mm.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a side view of a number of layers of a touch screen protector;

FIG. 2 is a perspective view of a screen protector ready for applying to a display screen;

FIG. 3 is a side view of a number of layers of another aspect of the screen protector;

FIG. 4 is a side view of a number of layers of a further aspect of the screen protector;

FIG. 5 is a side view of a number of layers of another aspect of the screen protector; and

FIG. 6 is a side view of a number of layers of another embodiment of the screen protector.

### DETAILED DESCRIPTION

Display protectors and/or touch screen protectors may be disposed of and replaced more often than other types of plastics. For example, the protectors may become excessively scratched and/or a visual clarity may be reduced. The plastic used in the protectors may degrade when exposed to the environment. The protectors may also build up with bacteria and microbes unless treated regularly and the treatment may increase the degradation. Often removal and disposal of the screen protection may be preferred thereby increasing an impact on the environment as the plastic and/or glass ends up in landfills. A recyclable and/or biodegradable touch screen protector may reduce the impact on the environment and/or provide other advantages.

Recycling certification standards provide a set of requirements for a plastic to be considered “biodegradable” or “compostable”. The requirements may involve specifying a break down to a specified degree, over a minimum period of time, and/or when exposed to a certain minimum temperature, and/or other physical conditions.

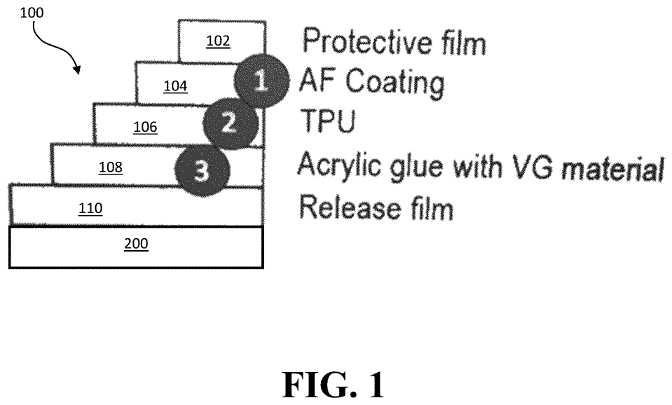

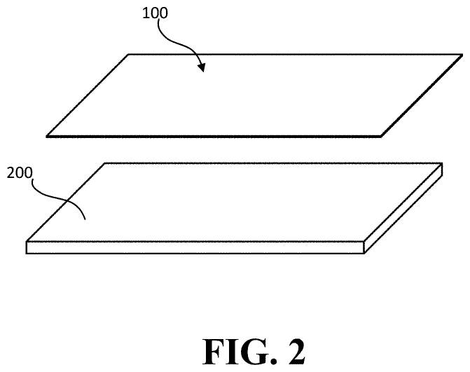

Turning to FIGS. 1 and 2, a display or touch screen protector 100 for a digital display screen 200, such as digital cameras, mobile phones, automobile displays, watches, etc., comprises a number of layers (e.g. multi-layer) 102-110. The protector 100 may be applied without special tools to the display screen 200, such as monitors, interactive flat panels, cell phones, tablets, laptops, and/or pad computer devices. In some aspects, the protector 100 may be applied in dusty environments. In order for the display screen 200 to be visible and/or free of distortion, each of the layers 102-110 may be optically clear or near optically clear. In this aspect, the protector 100 may be designed and/or die-cut to match a shape and/or dimensions of the display screen 200 and may include cut-outs for cameras, microphones, environmental monitors, device buttons, etc. The protector 100 may be flat or curved.

The protector 100 may comprise a plurality of layers 102-110 laminated together to form a film. In another aspect, the protector 100 may have only the core layer 106 as described in further detail below. The core layer 106 may be applied on top of or beneath existing protectors or applied on its own without other protectors.

The outermost layer 102 may be a protective film 102 to provide a scratch resistant surface. The protective film 102 may have a hardness between HD to 9H hardness. The protective film 102 may be chemically treated to provide a smooth surface for touching. In one aspect, the protective film may also be a protective release layer that can be peeled off when the protector 100 is installed.

In this aspect, an antimicrobial (AF) and/or antibacterial layer 104 may be beneath the protective film 102. Other aspects may not have the AF layer 104. In this aspect, the AF layer 104 may be formed of octadecyl dimethyl (3-trimethoxysilylpropyl) ammonium chloride such as produced by Zoono Group Limited of New Zealand. In other aspects, the AF layer 104 may be formed of silver or copper antimicrobial films.

A core layer 106 of the protector 100 may be formed from a biodegradable polylactic acid (PLA) resin material. The PLA resin may be turned into a clear bio-plastic, such as a polyethylene terephthalate (PET), a thermoplastic urethane (TPU), and/or a thermoplastic polyurethane. The process for turning the PLA resin into the clear bio-plastic may involve first a creation of a chitin nanocrystal formation. The nanocrystal formation may involve mixing distilled water with an emulsifying agent such as sodium lauryl sulfonate and methyl methacrylate in a ratio of approximately 100:1:20. The mixture may be heated to approximately 70° C. forming a methyl methacrylate emulsion. With a microwave, a chitin nanocrystal may be formed of approximately 25% by weight within the methyl methacrylate emulsion. An initiator, such as potassium thiosulfate, may be added in an amount of 1% by weight and then the emulsion may be heated to 85° C. A polyreaction may take place around the chitin nanocrystal within approximately 1 hour from adding the initiator. The reaction may then be terminated using with aluminum sulfate being added to the emulsion. Distilled water may wash the emulsion at 60° C. and then the emulsion may be dried for approximately 8 hours to obtain a chitin nanocrystal polymethylmethacrylate coating.

In the second step, chitin nanocrystal polymethylmethacrylate may be mixed with polylactic acid, homopolymerization tetracarboxylic acid dianhydride, oligopolymer polylactic acid, and three-nonylphenol phosphorous acid ester. In this aspect, the ratios may be as follows: 100 weight parts of polylactic acid, 8 weight parts of chitin nanocrystal polymethylmethacrylate, 0.8 weight parts of homopolymerization tetracarboxylic acid dianhydride, 3 weight parts of oligopolymer polylactic acid, and 0.2 weight parts of three-nonylphenol phosphorous acid ester.

The mixture from the second step may be dehumidified at 80° C. for 5 hours and then processed through an extrusion molding machine with a forcing machine having a single screw diameter of about 90 mm, length-to-diameter ratio of about 30:1, and a compression ratio of about 2.8:1. The extruder temperature may range from 170° C. to 200° C. with a head temperature of between 210° C. to 220° C. The resulting sheet may be spooled on a drum cooler with a temperature of 25° C. The sheet may be laminated with other layers to form the protector 100.

In one aspect, PLA resin material may be replaced with recycled PET or recycled glass.

In some aspects, PET may be used for an inflexible protector 100 whereas the TPU may be used for a flexible protector 100. For the inflexible protector 100, a thickness may be between about 0.1 mm to about 0.23 mm. For the flexible protector 100, the thickness may be between about 0.08 mm to about 0.18 mm.

In another aspect, the protector 100 may have a finish being glossy, matte, privacy, and/or antiglare applied to the outer layer.

The bioplastic layer 106 may be adhered to the display screen 200 using static properties of an adhesive layer 108, such as acrylic glue with VG material or blue light filtering material. The blue light material filters light with a wavelength generally in the blue spectrum (e.g. a wavelength of approximately 400-nm to approximately 530-nm) created by the display screen 200. In another aspect, a release layer 110 may be adhered to the bioplastic layer 106 via the adhesive layer 108. The release layer 110 may be peeled off when the protector 100 is ready for use.

In another aspect, the protector 100 may comprise a blue light filter layer using a chemical finish applied to the bioplastic layer 106 to filter out a wavelength of approximately 400-nm to approximately 530-nm. Such a process may be described in Chinese Pat. No. 203410122U, herein incorporated by reference in its entirety. The protector 100 may be manufactured with a thermoplastic sheet extrusion machine, such as produced by Primex Plastics (https://www.primexplastics.co.uk/extrusion).

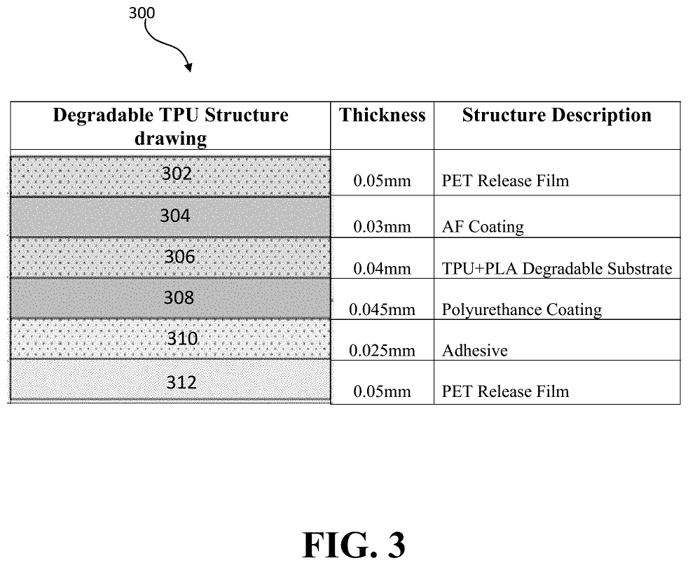

Now turning to FIG. 3, a protector 300 having a degradable TPU structure for a flexible protector according to a second aspect is shown. The protector 300 may have a core layer 306. The core layer 306 may be formed of a combination of TPU and PLA biodegradable material as a substrate with a thickness of 0.04 mm.

Similarly to the first aspect, an AF layer 304 formed of octadecyl dimethyl ammonium chloride, or silver/copper antimicrobial film may be on top of the core layer 306. In this aspect, the AF layer 304 may have a thickness of 0.03 mm. According to some aspects, a top release layer 302 formed of biodegradable material such PET film may be located on top of the AF layer 304. The top release layer 302 may be peeled off when the protector 300 has been applied on a display screen and ready for users to use. Alternatively, a protective film may also be beneath the top release layer 302. After the top release layer 302 is peeled off, the protective film may provide resistant to scratches.

According to another aspect, a layer of polyurethane coating 308, such as a layer having a thickness of 0.045 mm, may be formed beneath the core layer 306. Polyurethane is a soft material and can have a shock resistant function to protect the display screen 200.

In a further aspect, a bottom release layer 312 formed of biodegradable PET film may be adhered to the polyurethane coating 308 via the adhesive layer 310. The bottom release layer 312 may also be peeled off when the protector 300 is ready for applying to a display screen. In this embodiment, the PET release film for the top layer and the bottom release layer 312 may have a thickness of 0.05 mm.

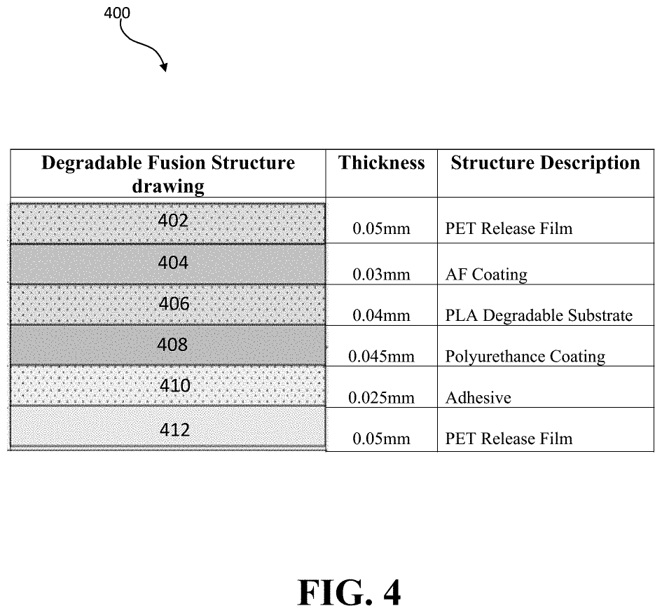

Now turning to FIG. 4, a protector 400 having a degradable fusion structure for an inflexible protector according to a further embodiment is shown. One difference between the inflexible protector 400 and the flexible protector 300 is the core layer. The core layer 406 of the inflexible protector 400 is formed of PLA biodegradable material as a substrate without TPU material.

Similar to the second aspect, the inflexible protector 400 may also have a layer of AF coating 404 on top of the core layer 406. A top layer 402 formed of degradable PET film is located on top of the AF coating 404. There may be a layer of polyurethane coating 408 beneath the core layer 406. A bottom release layer 412 formed of degradable PET film may also be adhered to the layer of polyurethane coating 408 via an adhesive layer 410. The bottom release layer 412 may be peeled off when the protector 400 is ready for applying to a display screen. Of course, the top release layer 402 may also be peeled off after the protector has been applied to a touch display screen or when users feel comfortable to do so. In this aspect, the thickness of the core layer 406, the AF coating 404, the top release layer 402, the polyurethane coating 408, the adhesive layer 410 and the bottom release layer 412 may have the same thickness as the corresponding layer in the second aspect. However, persons skilled in the art would understand that the thickness of each layer may vary as long as the properties and the total thickness of the protector meet the needs of the market.

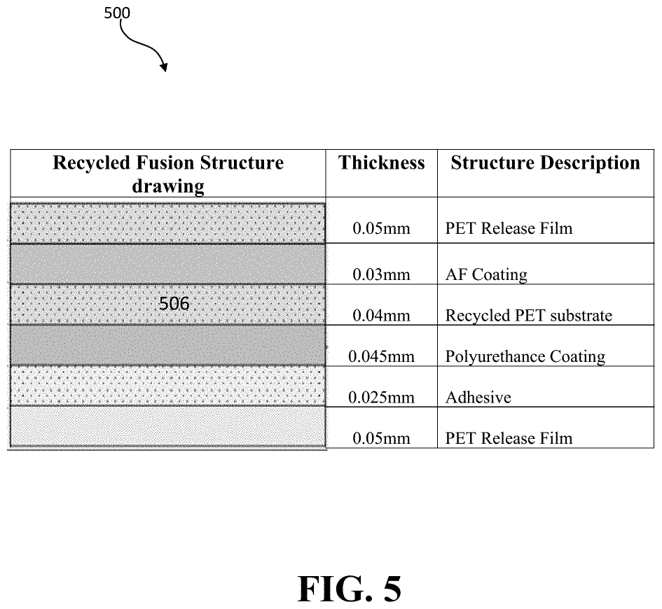

FIG. 5 shows a protector 500 having a recycled fusion structure according to another aspect. The protector 500 has the similar layer structure as the protector 300 and 400, for example, including a PET release film on the top, an AF coating, a core layer, a polyurethane coating, an adhesive layer, and a PET release file on the bottom as previously described. Numbering of these layers has been omitted from FIG. 5 to improve clarity of the drawing. One difference of the protector 500 with the previously described aspects is the core layer 506. The core layer 506 of the protector 500 is formed of a recycled PET as the substrate.

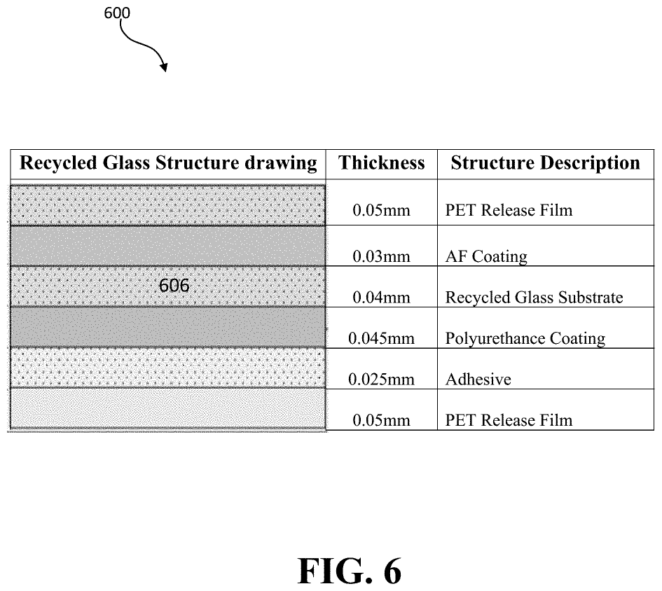

FIG. 6 shows a further example protector 600 having a recycled glass structure. The protector 600 also has the similar layer structure as other protectors discussed above, which may comprise a PET release film on the top, an AF coating, a core layer, a polyurethane coating, an adhesive layer, and a PET release file on the bottom. Numbering of these layers has been omitted from FIG. 6 to improve clarity of the drawing. One difference of the protector 600 is the core layer 606. The core layer 606 of the protector 600 is formed of a recycled glass as the substrate.

Narancic et al., Environ. Sci. Technol. 2018, 52, 18, 10441-10452 discloses testing neat polymers, polylactic acid (PLA), polyhydroxybutyrate, polyhydroxyoctanoate, poly(butylene succinate), thermoplastic starch, polycaprolactone (PCL), and blends thereof for biodegradation across seven managed and unmanaged environments. PLA when blended with PCL becomes home compostable. It also demonstrates that the majority of the tested bioplastics and their blends degrade by thermophilic anaerobic digestion with high biogas output, but degradation times are 3-6 times longer than the retention times in commercial plants. While some polymers and their blends showed good biodegradation in soil and water, the majority of polymers and their blends tested in this study failed to achieve ISO and ASTM biodegradation standards, and some failed to show any biodegradation. Thus, biodegradable plastic blends need careful postconsumer management, and further design to allow more rapid biodegradation in multiple environments is needed as their release into the environment can cause plastic pollution.

Karamanlioglu et al., Polymer Degradation and Stability, Vol. 137, March 2017, pg. 122-130 discloses poly(lactic acid) (PLA) being a compostable bioplastic manufactured by the polymerization of lactic acid monomers derived from the fermentation of starch as a feedstock. PLA is used as a replacement to conventional petrochemical based plastics, principally as food packaging containers and films and more recently, in electronics and in the manufacture of synthetic fibres. Consequently, there has been a marked increase in PLA contamination in the environment as well as increasing amounts being diverted to commercial composting facilities. This review focuses on the development, production, stability and degradation of PLA in a range of differing environments and explores our current knowledge of the environmental and biological factors involved in PLA degradation.

Garrison et al., Polymers 2016, 8, 262 discloses a variety of renewable starting materials, such as sugars and polysaccharides, vegetable oils, lignin, pine resin derivatives, and proteins, have so far been investigated for the preparation of bio-based polymers. Among the various sources of bio-based feedstock, vegetable oils are one of the most widely used starting materials in the polymer industry due to their easy availability, low toxicity, and relative low cost. Another bio-based plastic of great interest is poly(lactic acid) (PLA), widely used in multiple commercial applications. There is an intrinsic expectation that bio-based polymers are also biodegradable, but in reality there is no guarantee that polymers prepared from biorenewable feedstock exhibit significant or relevant biodegradability. Biodegradability studies are therefore crucial in order to assess the long-term environmental impact of such materials. This review presents a brief overview of the different classes of bio-based polymers, with a strong focus on vegetable oil-derived resins and PLA. An entire section is dedicated to a discussion of the literature addressing the biodegradability of bio-based polymers.

Prieto, Microbial Biotechnology (2016) 9(5), 652-657 discloses PLA is absorbed in animals and humans and, hence, it is extensively used in biomedicine. The degradation of the polymer in animals and humans is thought to occur via non-enzymatic hydrolysis. Several enzymes can degrade the polymer, including proteinase K, pronase and bromelain. However, few have been characterized with regard to microbial degradation of the polymer. PLA is also readily degraded in compost.

Lu et al., ACS Sustainable Chem. Eng. 2014, 2, 12, 2699-2706 discloses poly(lactic acid) (PLA) and distiller's dried grains with solubles (DDGS) are biobased materials with strong potential for industrial applications. This paper reports the biodegradation behavior of PLA/DDGS (80/20 by weight), a composite material developed for use in high-quality, economical, biodegradable, crop containers for the horticulture industry. Biodegradation experiments were performed in soil under landscape conditions. Surface morphology and thermal properties were evaluated by scanning electron microscopy (SEM), dynamic mechanical analysis (DMA), and differential scanning calorimetry (DSC). The paper found that adding 20% DDGS to form the PLA/DDGS composite can accelerate the biodegradation rate and enhance the storage modulus compared to pure PLA. The weight loss of the PLA/DDGS composite during 24 weeks of degradation time was 10.5%, while the weight loss of pure PLA was only 0.1% during the same time interval. Cracks and voids caused by erosion and loss of polymer chain length were clearly observed on the surface of the composite material in response to increasing degradation time. The thermal stability of the composite increased with increasing degradation time. The glass transition temperature and melting temperature increased during early stages of biodegradation (up to 16 weeks) and then decreased slightly. The paper confirms that DDGS can function as a cost-effective biodegradable filler for PLA composites that can provide enhanced mechanical properties with only slight changes in thermal properties when compared to pure PLA.

Haystad, Plastic Waste and Recycling, Chapter 5, Academic Press, 2020 discloses PLA degrades in the environment ranging from 6 months to 2 years, depending on the size and shape of the product, its isomer ratio, and the temperature. The tensile properties of PLA can vary widely depending on whether it is annealed or oriented or its degree of crystallinity.

Tiwari et al., International Journal of Research—Granthaalayah, Vol.6 (Iss.6): June 2018 discloses Polymers that easily degrade in the presence of water include poly-anhydrides, aliphatic polyesters with short mid-blocks like poly-lactic acid and certain poly (amino acids) like poly (glutamic acid). Poly-lactic acid (PLA) is linear aliphatic polyester produced by poly-condensation of naturally produced lactic acid or by the catalytic ring opening of the lactide group. Lactic acid is produced (via starch fermentation) as a co-product of corn wet milling. The ester linkages in PLA are sensitive to both chemical hydrolysis and enzymatic chain cleavage. PLA is frequently blended with starch to increase biodegradability and reduce costs. However, the brittleness of the starch-PLA blend is a major drawback in many applications. To remedy this limitation, a number of low molecular weight plasticizers such as glycerol, sorbitol and triethyl citrate are used. A number of companies produce PLA, such as Cargill Dow LLC. PLA produced by Cargill Dow was originally sold under the name Eco PLA, but now is known as Nature Works PLA, which is actually a family of PLA polymers that can be used alone or blended with other natural-based polymers (Developing Products that Protect the Environment, 2007). The applications for PLA are thermoformed products such as drink cups, take-away food trays, containers and planter boxes. The material has good rigidity characteristics, allowing it to replace poly-stryene and PET in some applications. PLA is fully biodegradable when composted in a large-scale operation with temperatures of 60° C. and above. The first stage of degradation of PLA (two weeks) is via hydrolysis to water-soluble compounds and lactic acid. Rapid metabolisation of these products into CO2, water and biomass by a variety of microorganisms.

Acquavia et al., Agro-Food Sector. Polymers 2021, 13, 158 discloses poly lactic acid (PLA)-based bioplastics are obtained from a fermentative process that involves conversion of corn, or other carbohydrate sources into dextrose, followed by fermentation/conversion into lactic acid [25]. Thus, lactic acid is isolated and polymerized to yield a low molecular weight, brittle polymer whose chain length could be increased by using external coupling agents.

The above detailed description of the aspects of the invention is not intended to be exhaustive or to limit the invention to the precise form disclosed above or to the particular field of usage mentioned in this disclosure. While specific aspects of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various aspects described above can be combined to provide further aspects.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain aspects of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A display protector comprising:
a top layer;
an antimicrobial (AF) layer beneath the top layer;
a core layer formed of a biodegradable material beneath the AF layer;
an adhesive layer beneath the core layer; and
a bottom release layer beneath the adhesive layer, the bottom release layer releasably adhered to the core layer.

2. The display protector of claim 1, wherein the top layer is a protective film having a hardness between HD to 9 H hardness.

3. The display protector of claim 1, wherein the top layer is a release film formed of a biodegradable polyethylene terephthalate (PET), and has a thickness of 0.05 mm.

4. The display protector of claim 1, wherein the AF layer is formed from any one of: an octadecyl dimethyl (3-trimethoxysilylpropyl) ammonium chloride, a silver antimicrobial film, a copper antimicrobial film, and any combination thereof.

5. The display protector of claim 1, wherein the biodegradable material of the core layer is any one of: a biodegradable polylactic acid (PLA) resin material, a recycled PET, a recycled glass, and any combination thereof.

6. The display protector of claim 1, wherein the biodegradable material of the core layer is a combination of a biodegradable thermoplastic urethane (TPU) and a PLA material.

7. The display protector of claim 5, wherein the core layer has a thickness of 0.04 mm.

8. The display protector of claim 6, wherein the core layer has a thickness of 0.04 mm.

9. The display protector of claim 1, wherein the bottom release layer is formed of a biodegradable PET and has a thickness of 0.05 mm.

10. The display protector of claim 1, further comprising a layer of polyurethane coating between the core layer and the adhesive layer.

11. The display protector of claim 1, further comprising a blue light filter layer applied to the core layer to filter out a wavelength of approximately 400-nm to approximately 530-nm.

12. The display protector of claim 1, wherein the screen protector has a total thickness between about 0.08 mm to about 0.23 mm.

13. The display protector of claim 12, wherein the biodegradable material of the core layer is formed comprising a creation of a chitin nanocrystal formation.

14. The display protector of claim 13, wherein the chitin nanocrystal formation involves mixing distilled water with sodium lauryl sulfonate and methyl methacrylate in a ratio of approximately 100:1:20 to form a chitin nanocrystal polymethylmethacrylate.

15. The display protector of claim 14, wherein the chitin nanocrystal polymethylmethacrylate is mixed with a polylactic acid, a homopolymerization tetracarboxylic acid dianhydride, an oligopolymer polylactic acid, and a three-nonylphenol phosphorous acid ester.
